(19) United States
(12) Patent Application Publication
(10) Pub. No.: US 2025/0018645 A1
(43) Pub. Date: Jan. 16, 2025

(54) SYSTEM FOR ADDITIVE MANUFACTURING

(71) Applicant: Continuous Composites Inc., Coeur d'Alene, ID (US)

(72) Inventors: Nathan Andrew STRANBERG, Post Falls, ID (US); Andrew John Overby, Coeur d'Alene, ID (US); Colin Hugh Hambling, Medina, WA (US)

(73) Assignee: Continuous Composites Inc., Coeur d'Alene, ID (US)

(21) Appl. No.: 18/903,233

(22) Filed: Oct. 1, 2024

Related U.S. Application Data
(63) Continuation of application No. 17/652,376, filed on Feb. 24, 2022, now Pat. No. 12,128,615.
Application No. 17/652,376 is a continuation of application No. 16/660,519, filed on Oct. 22, 2019, now Pat. No. 11,292,192.
(60) Provisional application No. 62/769,498, filed on Nov. 19, 2018.

(51) Int. Cl. B29C 64/209; B29C 64/118; B29C 64/321; B29C 64/393; B33Y 30/00; B33Y 50/02

(52) U.S. Cl. CPC B29C 64/209; B29C 64/118; B29C 64/321; B29C 64/393; B33Y 30/00; B33Y 50/02

(57) ABSTRACT

A system is disclosed for additively manufacturing a composite structure. The system may include a support, a discharge head connected to and moveable by the support, a supply of reinforcement, and a rotary tensioner located between the supply and the discharge head. The rotary tensioner may be configured to impart tension to the reinforcement and to generate a signal indicative of the tension. The system may further include a drive associated with the supply, and a controller in communication with the rotary tensioner and the drive. The controller may be configured to selectively adjust a feed parameter of the drive based on the signal to maintain a desired level of tension.

### RELATED APPLICATIONS

This application is a continuation of U.S. Non-Provisional application Ser. No. 17/652,376 that was filed on Feb. 24, 2022, which is continuation of U.S. Non-Provisional application Ser. No. 16/660,519 that was filed on Oct. 22, 2019, which is based on and claims the benefit of priority from U.S. Provisional Application No. 62/769,498 that was filed on Nov. 19, 2018, the contents of all of which are expressly incorporated herein by reference.

### TECHNICAL FIELD

The present disclosure relates generally to a manufacturing system and, more particularly, to a system for additively manufacturing composite structures and a method of operating the system.

### BACKGROUND

Continuous fiber 3D printing (a.k.a., CF3D®) involves the use of continuous fibers that are at least partially coated with a matrix inside of a moveable print head, just prior to discharge from the print head. The matrix can be a thermoplastic, a thermoset, a powdered metal, or a combination of any of these and other known matrixes. Upon exiting the print head, a head-mounted cure enhancer (e.g., a UV light, an ultrasonic emitter, a heat source, a catalyst supply, etc.) is activated to initiate and/or complete curing of the matrix. This curing occurs almost immediately, allowing for unsupported structures to be fabricated in free space, without the need for a mold or an autoclave. An example of this technology is disclosed in U.S. Pat. No. 9,511,543 that issued to Tyler on Dec. 6, 2016 (“the '543 patent”). CF3D® may be inexpensive, fast, and efficient, as the use of autoclaves, molds, and manual labor associated with traditional composite manufacturing may be reduced or even eliminated.

Although CF3D® may be inexpensive, fast, and efficient, improvements can be made to the structure and/or operation of existing systems. For example, a strength of the resulting structure may be at least partially dependent on alignment and engagement of each of the reinforcements within the structure. Straighter fibers that are all engaged equally may result in a stronger structure. However, this can be difficult to achieve. The disclosed additive manufacturing system and method are uniquely configured to provide these improvements and/or to address other issues of the prior art.

### SUMMARY

In one aspect, the present disclosure is directed to a support, a discharge head connected to and moveable by the support, a supply of reinforcement, and a rotary tensioner located between the supply and the discharge head. The rotary tensioner may be configured to impart tension to the reinforcement and to generate a signal indicative of the tension. The system may further include a drive associated with the supply, and a controller in communication with the rotary tensioner and the drive. The controller may be configured to selectively adjust a feed parameter of the drive based on the signal to maintain a desired level of tension.

In another aspect, the present disclosure is directed to a tension arrangement for use with a discharge head. The tension arrangement may include a rotary tensioner configured to generate tension within a reinforcement passing into the discharge head and to generate a signal indicative of the tension. The tension arrangement may also include a drive responsive to the signal to adjust a feed parameter of the reinforcement.

### BRIEF DESCRIPTION OF THE DRAWINGS

FIG. 1 is a diagrammatic and cross-sectional illustration of an exemplary disclosed additive manufacturing system;

FIG. 2 is an enlarged isometric illustration of an exemplary portion of the additive manufacturing system of FIG. 1; and

FIG. 3 is a side-view illustration of an alternative exemplary portion of the additive manufacturing system of FIG. 1.

### DETAILED DESCRIPTION

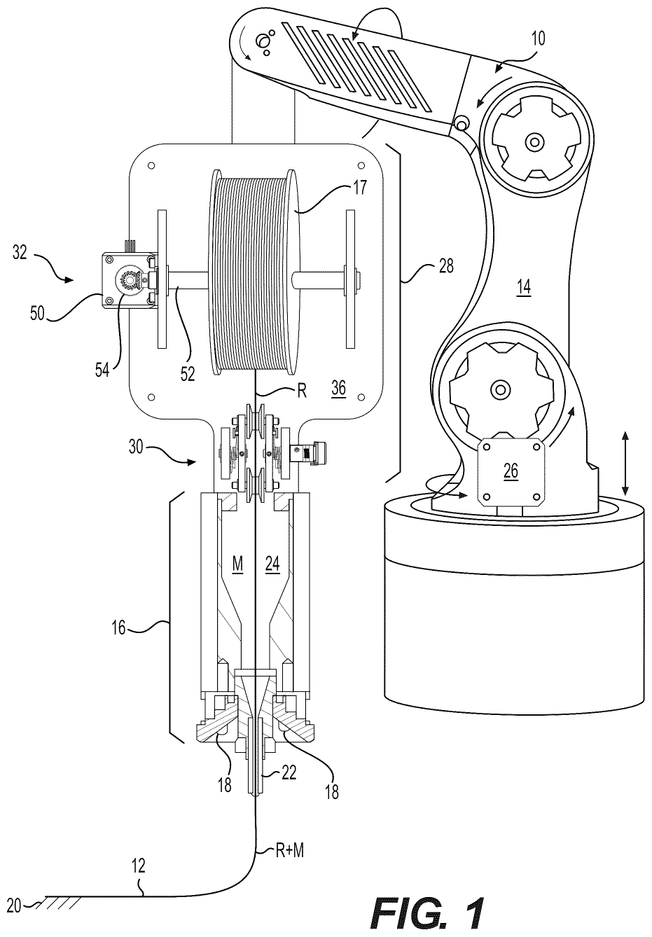

FIG. 1 illustrates an exemplary system 10, which may be used to manufacture a composite structure 12 having any desired shape. System 10 may include a support 14 and deposition head (“head”) 16. Head 16 may be coupled to and moved by support 14. In the disclosed embodiment of FIG. 1, support 14 is a robotic arm capable of moving head 16 in multiple directions during fabrication of structure 12. Support 14 may alternatively embody a gantry (e.g., an overhead bridge or single-post gantry) or a hybrid gantry/arm also capable of moving head 16 in multiple directions during fabrication of structure 12. Although support 14 is shown as being capable of 6-axis movements, it is contemplated that support 14 may be capable of moving head 16 in a different manner (e.g., along or around a greater or lesser number of axes). In some embodiments, a drive may mechanically couple head 16 to support 14, and include components that cooperate to move portions of and/or supply power or materials to head 16.

Head 16 may be configured to receive or otherwise contain a matrix (shown as M in FIG. 1). The matrix may include any type of matrix (e.g., a liquid resin, such as a zero-volatile organic compound resin, a powdered metal, etc.) that is curable. Exemplary resins include thermosets, single- or multi-part epoxy resins, polyester resins, cationic epoxies, acrylated epoxies, urethanes, esters, thermoplastics, photopolymers, polyepoxides, thiols, alkenes, thiolenes, and more. In one embodiment, the matrix inside head 16 may be pressurized, for example by an external device (e.g., by an extruder, a pump, etc.—not shown) that is fluidly connected to head 16 via a corresponding conduit (not shown). In another embodiment, however, the pressure may be generated completely inside of head 16 by a similar type of device. In yet other embodiments, the matrix may be gravity-fed into and/or through head 16. For example, the matrix may be fed into head 16, and pushed or pulled out of head 16 along with one or more continuous reinforcements (shown as R in FIG. 1). In some instances, the matrix inside head 16 may need to be kept cool and/or dark in order to inhibit premature curing or otherwise obtain a desired rate of curing after discharge. In other instances, the matrix may need to be kept warm and/or illuminated for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, socks, and/or sheets of continuous material) and, together with the reinforcements, make up a portion (e.g., a wall) of composite structure 12. The reinforcements may be stored within or otherwise passed through head 16 (e.g., fed from one or more spools 17). When multiple reinforcements are simultaneously used, the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, plastic fibers, metallic wires, optical tubes, etc. It should be noted that the term “reinforcement” is meant to encompass both structural and non-structural (e.g., functional) types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry (e.g., unimpregnated) reinforcements, and/or reinforcements that are already exposed to the matrix may be transported into head 16 in any manner apparent to one skilled in the art. In some embodiments, a filler material (e.g., chopped fibers, nano particles or tubes, etc.) may be mixed with the matrix before and/or after the matrix coats the continuous reinforcements.

One or more cure enhancers (e.g., a UV light, an ultrasonic emitter, a laser, a heater, a catalyst dispenser, etc.) 18 may be mounted proximate (e.g., within, on, and/or adjacent) head 16 and configured to enhance a cure rate and/or quality of the matrix as it is discharged from head 16. Cure enhancer 18 may be controlled to selectively expose portions of structure 12 to energy (e.g., UV light, electromagnetic radiation, vibrations, heat, a chemical catalyst, etc.) during material discharge and the formation of structure 12. The energy may trigger a chemical reaction to occur within the matrix, increase a rate of the chemical reaction, sinter the matrix, harden the matrix, or otherwise cause the matrix to cure as it discharges from head 16. The amount of energy produced by cure enhancer 18 may be sufficient to cure the matrix before structure 12 axially grows more than a predetermined length away from head 16. In one embodiment, structure 12 is completely cured before the axial growth length becomes equal to an external diameter of the matrix-coated reinforcement.

The matrix and/or reinforcement may be discharged from head 16 via at least two different modes of operation. In a first mode of operation, the matrix and/or reinforcement are extruded (e.g., pushed under pressure and/or mechanical force) from head 16 as head 16 is moved by support 14 to create features of structure 12. In a second mode of operation, at least the reinforcement is pulled from head 16 (and also from spool 17, in some embodiments), such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is being pulled from head 16 with the reinforcement, the resulting tension in the reinforcement may increase a strength of structure 12 (e.g., by aligning the reinforcements, inhibiting buckling, etc.) after curing of the matrix, while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor point 20. In particular, at the start of structure formation, a length of matrix-impregnated reinforcement may be pulled and/or pushed from head 16, deposited onto anchor point 20, and cured, such that the discharged material adheres (or is otherwise coupled) to anchor point 20. Thereafter, head 16 may be moved away from anchor point 20, and the relative movement may cause the reinforcement to be pulled from head 16. It should be noted that the movement of reinforcement through head 16 could be assisted via internal feed mechanisms, if desired. However, the discharge rate of reinforcement from head 16 may primarily be the result of relative movement between head 16 and anchor point 20, such that tension is created within the reinforcement. As discussed above, anchor point 20 could be moved away from head 16 instead of or in addition to head 16 being moved away from anchor point 20.

As can be seen in FIG. 1, head 16 may include, among other things, an outlet 22 and a matrix reservoir 24 located upstream of outlet 22. In this example, outlet 22 is a single-channel nozzle configured to discharge composite material having a generally circular, tubular, or rectangular cross-section. The configuration of head 16, however, may allow outlet 22 to be swapped out for another outlet (not shown) that discharges composite material having a different shape (e.g., a flat or sheet-like cross-section, a multi-track cross-section, etc.). Fibers, tubes, and/or other reinforcements may pass through matrix reservoir 24 and be wetted (e.g., at least partially coated and/or fully saturated) with matrix prior to discharge.

A controller 26 may be provided and communicatively coupled with support 14 and head 16. Each controller 26 may embody a single processor or multiple processors that are configured to control an operation of system 10. Controller 26 may include one or more general or special purpose processors or microprocessors. Controller 26 may further include or be associated with a memory for storing data such as, for example, design limits, performance characteristics, operational instructions, tool paths, and corresponding parameters of each component of system 10. Various other known circuits may be associated with controller 26, including power supply circuitry, signal-conditioning circuitry, solenoid driver circuitry, communication circuitry, and other appropriate circuitry. Moreover, controller 26 may be capable of communicating with other components of system 10 via wired and/or wireless transmission.

One or more maps may be stored in the memory of controller 26 and used during fabrication of structure 12. Each of these maps may include a collection of data in the form of lookup tables, graphs, and/or equations. In the disclosed embodiment, the maps may be used by controller 26 to determine the movements of head 16 required to produce desired geometry (e.g., size, shape, material composition, performance parameters, and/or contour) of structure 12, and to regulate operation of cure enhancer(s) 18 and/or other related components in coordination with the movements.

In some embodiments, a tension arrangement (“arrangement”) 28 may be associated with head 16. Arrangement 28 may help to maintain a tension within individual reinforcements passing from spool 17 through outlet 22. This may help system 10 to produce structures 12 having predictable performance and to avoid malfunctions during printing (particularly when changing print directions and/or orientations). For example, when some reinforcements are in greater tension than other reinforcements in the same structure, the higher-tension reinforcements carry more of a load placed on structure 12. These reinforcements are then at greater risk for damage and/or failure during use. Similarly, excessively high reinforcement tension inside of head 16 could cause the reinforcements to break, resulting in delayed processing and/or rejected structures 12. In contrast, reinforcements that are in low or no tension generally do not contribute to performance of the part and add only excess weight. In addition, low levels of tension could cause bunching of the reinforcements inside of head 16. Uneven levels of tension between the reinforcements can also create distortions in structure 12 during fabrication. Arrangement 28 may be beneficial to help ensure a desired and uniform level of tension within all of the reinforcements passing through head 16.

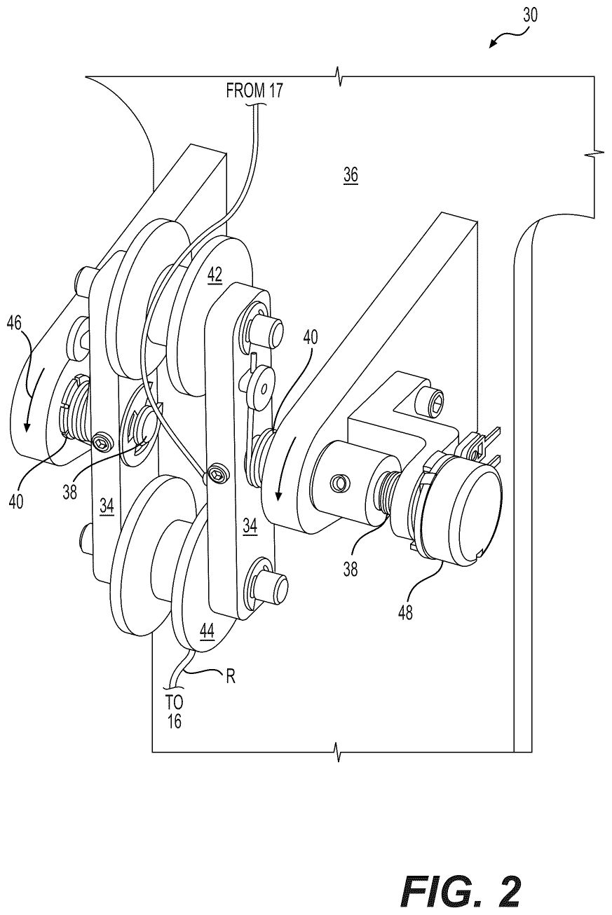

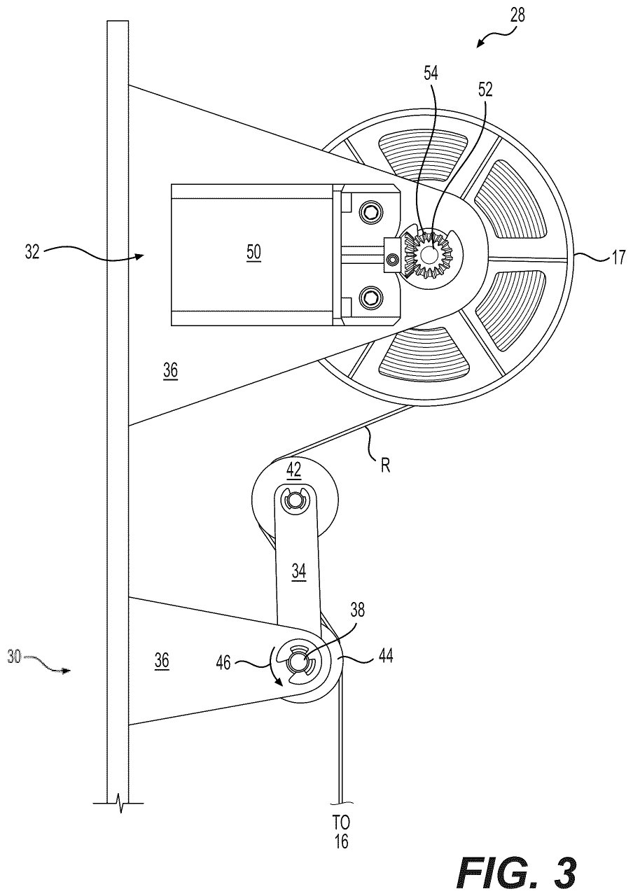

In the embodiments of FIGS. 1, 2, and 3, arrangement 28 is illustrated as a rotary-type of arrangement, including a tensioner 30 located between spool 17 and outlet 22, and a variable drive 32 associated with spool 17. As shown in FIGS. 2 and 3, tensioner 30 may be an assembly of components including, among other things, one or more arms (e.g., spaced apart elongated plates) 34 that are pivotally connected to a bracket 36 by way of one or more axels 38. In one embodiment, outlet 22 and/or spool 17 are mounted to the same bracket 36. One or more springs (e.g., coil springs) 40 may be disposed between arms 34 and bracket 36 to bias arms 34 away from a neutral rotational angle (shown in FIG. 2). Any number of pulleys or rollers (e.g., an upstream pulley 42 and a downstream pulley 44) may be mounted to arms 34 (e.g., at opposing ends thereof), and the reinforcements from spool 17 may pass around pulleys 42, 44. When arms 34 are at the neutral rotational angle, the reinforcements may follow a straightest trajectory around pulleys 42, 44, from spool 17 through outlet 22. As spring(s) 40 pivots arms 34 away from the neutral rotational angle (e.g., in the direction of an arrow 46), the reinforcements may be moved into more of an S-shaped trajectory. As tension within the reinforcements increases, arms 34 may be pivoted against the bias of spring(s) 40 back towards the neutral position.

In some embodiments, the pivoting of arms 34 may be detected by a sensor 48. In one embodiment, sensor 48 is a rotary encoder that generates a signal indicative of the pivoting of arms 34 relative to the neutral rotational angle. In other embodiments, however, sensor 48 may be another type of sensor (e.g., a linear sensor associated with spring(s) 40, a potentiometer, etc.), if desired.

The signals generated by sensor 48 may be used (e.g., by controller 26) to selectively energize drive 32 (referring to FIG. 1). For example, in response to a signal indicating a greater amount of tension (e.g., greater rotation toward the neutral rotational angle), controller 26 may energize drive 32 a greater amount to cause more reinforcement to be dispensed and/or dispensed at a faster rate, thereby lowering the tension within the reinforcements. In contrast, in response to a signal indicating a lesser amount of tension (e.g., greater rotation away from the neutral rotational angle), controller 26 may energize drive 32 a lesser amount to cause less reinforcement to be dispensed and/or dispensed at a slower rate, thereby increasing the tension with the reinforcements. In this manner, reinforcement may be dispensed on an as-needed basis in order to maintain a desired and relatively consistent level of tension within all of the reinforcements. In one embodiment, arrangement 28 may maintain a tension within the reinforcements of less than about 5 lbs., with a resolution of about. 1-2 lbs.

Drive 32 may embody any type of automated spool driver known in the art. In one example, drive 32 includes a motor 50 operatively connected to a shaft 52 on which spool 17 may be mounted. In the disclosed embodiment, motor 50 is connected to shaft 52 via a gear mechanism (e.g., a pair of meshed bevel gears) 54. Based on a command from controller 26, motor 50 may selectively dispense an amount of reinforcement and/or reinforcement at a commanded rate.

FIG. 3 illustrates an alternative embodiment of tensioner 30. Tensioner 30 of FIGS. 2 and 3 differ primarily in the way that axel 38 connects arms 34 to bracket 36. In particular, axel 38 of FIG. 2 may actually be divided into two stub-axels, one associated with an opposing ear tab of bracket 36 and each of arms 34. In addition, the pivot point of arms 34 may be generally centered between their opposing ends in FIG. 2. Axel 38 of FIG. 3, however, may embody a monolithic component that passes completely through a common end of arms 34 and both ear tabs of bracket 36. The design of FIG. 3 may help to reduce tolerance stack-up associated with tensioner 30 and also provide a consistent guide point for reinforcement entering head 16 (i.e., downstream pulley 44 remains stationary in FIG. 3, allowing for less movement of the reinforcement within head 16 due to changes in tension).

### INDUSTRIAL APPLICABILITY

The disclosed system may be used to manufacture composite structures having any desired cross-sectional shape and length. The composite structures may include any number of different continuous fibers of the same or different types and of the same or different diameters, and any number of different matrixes of the same or different makeup. Operation of system 10 will now be described in detail.

At a start of a manufacturing event, information regarding a desired structure 12 may be loaded into system 10 (e.g., into controller 26 that is responsible for regulating operations of support 14 and/or head 16). This information may include, among other things, a size (e.g., diameter, wall thickness, length, etc.), a contour (e.g., a trajectory), surface features (e.g., ridge size, location, thickness, length; flange size, location, thickness, length; etc.), connection geometry (e.g., locations and sizes of couplings, tees, splices, etc.), functional requirements, matrix specifications (e.g., cure parameters), reinforcement specifications (e.g., desired tension levels), etc. It should be noted that this information may alternatively or additionally be loaded into system 10 at different times and/or continuously during the manufacturing event, if desired. Based on the component information, one or more different reinforcements and/or matrixes may be selectively installed and/or continuously supplied into system 10.

To install unimpregnated reinforcements into head 16, individual fibers, tows, and/or ribbons may be passed from spool 17 through tensioner 30 (e.g., between pulleys 42, 44), through matrix reservoir 24, through outlet 22, and past cure enhancer(s) 18. In some embodiments, the reinforcements may also need to be connected to a pulling machine (not shown) and/or to a mounting fixture (e.g., to anchor point 20). Installation of the matrix may include filling head 16 (e.g., reservoir 24) and/or coupling of an extruder or other source of pressurized matrix (not shown) to head 16.

The component information may then be used to control operation of system 10. For example, the in-situ wetted reinforcements may be pulled and/or pushed from head(s) 16 as support 14 selectively moves (e.g., based on known kinematics of support 14 and/or known geometry of structure 12) such that the resulting structure 12 is fabricated as desired. Operating parameters of cure enhancer(s) 18, arrangement 28 (e.g., tensioner 30 and/or drive 32) and/or other components of system 10 may be adjusted in real time during material discharge to provide for desired bonding, strength, and other characteristics of structure 12. Once structure 12 has grown to a desired length, structure 12 may be severed from system 10.

It will be apparent to those skilled in the art that various modifications and variations can be made to the disclosed system and methods. Other embodiments will be apparent to those skilled in the art from consideration of the specification and practice of the disclosed system and method. It is intended that the specification and examples be considered as exemplary only, with a true scope being indicated by the following claims and their equivalents.

What is claimed is:

1. A method for additively manufacturing a composite structure, comprising:
moving a print head with a support;
directing a reinforcement from a supply around a first end of a tensioner arm to a matrix reservoir in the print head;
wetting the reinforcement with a matrix in the matrix reservoir and discharging the matrix wetted reinforcement from the print head during the moving;
generating a signal indicative of pivoting of the tensioner arm; and
selectively adjusting operation of the supply based on the signal.

2. The method of claim 1, wherein the sensor is located at a second end of the tensioner arm opposite the first end.

3. The method of claim 2, wherein the tensioner arm further includes a redirecting device configured to rotate at the second end and engage the reinforcement.

4. The method of claim 1, further including exposing the matrix wetted reinforcement to cure energy at discharge from the print head.

5. The method of claim 1, wherein the supply is mounted to at least one of the support and the print head.

6. A method for additively manufacturing a composite structure, comprising:
operating a system to move a print head with a support;
imparting tension to a material passing through the print head using an arm having a first end pivotally connected to the print head and a second end engaging the material;
generating a signal indicative of pivoting of the arm; and
affecting operation of the system based on the signal.

7. The method of claim 6, further including directing the material from a supply mounted to at least one of the support and the print head to the arm.

8. The method of claim 7, wherein affecting operation of the system includes selectively adjusting a feed rate of the material from the supply based on the signal.

9. The method of claim 7, wherein selectively adjusting the feed rate is based at least in part on at least one of:
comparing an orientation of the arm to a threshold orientation; or
comparing the tension of the material to a threshold tension.

10. The method of claim 6, further including at least partially wetting the material with a matrix at a location downstream of the arm.

11. The method of claim 10, further including pulling the material through the tensioner and the location by moving the print head away from an anchor.

12. The method of claim 6, further including exposing the material to cure energy at discharge from the print head.

13. The method of claim 6, wherein the supply is mounted to at least one of the support and the print head.

14. A method for additively manufacturing a composite structure, comprising:
operating a system to move a print head with a support;
imparting tension to a reinforcement received at the print head using an arm having a first end pivotally connected to the print head and a redirecting device located at a second end opposite the first end; and
generating a signal via a sensor located at the first end of the arm.

15. The method of claim 14, wherein:
wherein the signal is indicative of operation of the tensioner; and
the method further includes selectively adjusting a feed rate of the reinforcement to the print head based at least in part on the signal.

16. The method of claim 15, further including:
directing the reinforcement from a supply to the print head; and
driving the supply with a motor,
wherein selectively adjusting the feed rate includes adjusting a drive speed of the motor.

17. The method of claim 16, wherein:
increasing the drive speed of the motor causes the arm to pivot in a first direction; and
decreasing the drive speed of the motor causes the arm to pivot in a second direction that is opposite the first direction.

18. The method of claim 17, further including making a comparison of an orientation of the arm detected by the sensor with a threshold orientation, wherein
selectively adjusting the feed rate includes selectively adjusting the feed rate based at least in part on the comparison.

19. The method of claim 14, further including biasing the arm toward the reinforcement.

20. The method of claim 14, further including exposing the reinforcement to cure energy at discharge from the print head.
